(19) United States
(12) Patent Application Publication
(10) Pub. No.: US 2010/0155642 A1
(43) Pub. Date: Jun. 24, 2010

(54) Offset Handle and Dual Connected Handle and Valves

(75) Inventors: Richard R. Weston, Nazareth, PA (US); Heng Yung, Stewartsville, NJ (US)

Correspondence Address: Ballard Spahr LLP, SUITE 1000, 999 PEACHTREE STREET, ATLANTA, GA, 30309-3915, US

(73) Assignee: Victaulic Company, Easton, PA (US)

(21) Appl. No.: 12/487,157

(22) Filed: Jun. 18, 2009

Related U.S. Application Data
(60) Provisional application No. 61/073,401, filed on Jun. 18, 2008.

(51) Int. Cl. F16K 31/60

(52) U.S. Cl. 251/289; 251/291; 251/356

(57) ABSTRACT

A handle and a valve actuated by the handle. The handle includes first and second handle portions offset from one another in one or two directions and joined by a linking portion. Offset handle portions allow one handle portion to be aligned with the centerline of the valve, or to be placed on an opposite side of the valve from the other handle portion.

### CROSS REFERENCE TO RELATED APPLICATION

This application is based upon and claims priority of U.S. Provisional Application No. 61/073,401 filed on Jun. 18, 2008.

### FIELD OF THE INVENTION

The invention concerns handles for manually actuated devices such as valves, and especially for valves positioned such that the valve is readily accessible from only one side.

### BACKGROUND OF THE INVENTION

It is often the case that manually operated devices, such as valves, are mounted within a structure wherein access to one side of the valve is blocked. A test and drain valve for a fire suppression sprinkler system in a building is an example of such a valve. Test and drain valves are often mounted on riser pipes in building stairwells and connect the riser pipe to a test line and the test line to a drain line. It is desired to position the drain line toward the warmer core of the building and away from colder outer walls to avoid freezing of the drain line in cold weather. For drain lines on opposite sides of a building, this means that the orientation of the valve connectivity will be mirror images of one another, with left and right reversed.

Often the test and drain valves are positioned adjacent to a wall or other building structure, with one side of the valve facing the wall or structure and the other side facing away therefrom. The valve controls, such as the actuation handle for opening and closing the valve, as well as the test/drain selector, are usually located on one side of the test and drain valve. For those valves positioned on the side of the building where the valve controls are on the side of the valve which faces away from the building structure, there is no problem with actuation of the test and drain function of the valve. The handle is visible on the one side of the valve, the handle being rotatable to open and close the valve to effect a test of the sprinkler system. However, for all such valves installed on the opposite side of the building, the valve controls will be on the side of the valve which faces the building structure. The controls are not readily visible, and access to them is limited by the orientation of the valve and the adjacent building structure. To actuate the test and drain function of such a valve, which must be done periodically, a technician is required to reach around behind the valve, grip the actuation handle and rotate it to open and close the valve.

For some reason, technicians become confused and have difficulty operating valves wherein the actuation handle is on the side of the valve which is not visible. A mirror image test and drain valve would be advantageous in this situation so that manual valve operation appears the same whether on one side of the building or the opposite side. It is, however, uneconomical to manufacture and install handed test and drain valves, so a single type of test and drain valve is most often installed in both applications, which results in limited access to controls of those valves positioned on one side of the building and all of the confusion which that entails.

It would be advantageous to have an actuation handle which helps avoid this confusion, thereby avoiding the need for handed valves.

### SUMMARY OF THE INVENTION

The invention concerns a handle for actuating a device. The handle comprises a first handle portion attachable to the device. The first handle portion is located in a first plane. A second handle portion is located in a second plane substantially parallel to and offset from the first handle portion in a direction substantially perpendicular to the first plane. The second handle portion is manually grippable. A linking portion connects the second handle portion to the first handle portion.

In one embodiment, the second handle portion is also offset from the first handle portion in a direction substantially parallel to the first plane.

In another embodiment of a handle for actuating a device, the handle comprises a first handle portion attachable to the device. The first handle portion is located in a first plane. A second handle portion is located in a second plane offset from the first handle portion in a direction substantially perpendicular to the first plane. The second handle portion is manually grippable. A linking portion connects the second handle portion to the first handle portion.

In one embodiment, the first and second planes are substantially parallel to one another. In another embodiment, the second handle portion is offset from the first handle portion in a direction substantially parallel to the first plane.

The invention also encompasses a valve comprising a housing having first and second sides oppositely disposed, and a centerline positioned therebetween. A closing member is mounted within the housing, the closing member being movable between an open position and a closed position. A valve stem is attached to the closing member and projects from the first side of the housing. Rotation of the valve stem moves the closing member between the open and the closed positions. A handle is mounted on the valve stem for manually opening and closing the valve. The handle comprises a first handle portion located in a first plane and attached to the valve stem and a second handle portion located in a second plane offset from the first plane and aligned with the centerline of the housing. A linking portion connects the second handle portion to the first handle potion.

In one valve embodiment, the first and second planes are oriented substantially parallel to one another. The second handle portion may be further offset from the first handle portion in a direction substantially parallel to the first and second planes.

In another embodiment of a handle for actuating a device, the handle comprises a first handle portion having a first end attachable to the device and a second end oppositely disposed from the first end. A second handle portion is offset from the first handle portion in spaced relation so as to be positionable on an opposite side of the device from the first handle portion. A linking portion having a first end attached to the first handle portion and a second end attached to the second handle portion joins the two handle portions.

In one embodiment, the second handle portion comprises a first end rotatably attachable to the device, and a second end, oppositely disposed from the first end of the second handle portion. The second end of the second handle portion is grippable for rotation of the handle. The linking portion may be attached at a position between the first and second ends of the first and the second handle portions.

The invention further encompasses a valve comprising a housing having first and second sides oppositely disposed. A closing member is mounted within the housing. The closing member is movable between an open position and a closed position. A valve stem is attached to the closing member and projects from the first side of the housing. Rotation of the valve stem moves the closing member between the open and the closed positions. A first handle portion has a first end which is attached to the valve stem and a second end oppositely disposed from the first end. A second handle portion is positioned on the second side of the housing. The second handle portion has a first end which may also be attached to the housing, and a second end, oppositely disposed to the first end. The second handle portion is rotatable about an axis, which may be coaxially aligned with the valve stem. The handle also includes a linking portion having a first end attached to the first handle portion and a second end attached to the second handle portion.

### BRIEF DESCRIPTION OF THE DRAWINGS

FIG. 1 is a side view of one embodiment of a handle according to the invention;

FIG. 2 is a bottom plan view of the embodiment shown in FIG. 1;

FIG. 3 is a side view of a valve using the handle shown in FIG. 1;

FIG. 4 is an opposite side view of the valve shown in FIG. 3;

FIG. 5 is a bottom plan view of the valve shown in FIG. 3;

FIG. 6 is an isometric view of another embodiment of a handle according to the invention;

FIG. 7 is a side view of a valve using the handle shown in FIG. 6; and

FIG. 8 is an opposite side view of the valve shown in FIG. 7.

### DETAILED DESCRIPTION OF THE EMBODIMENTS

FIG. 1 shows an example of an offset handle 10 according to the invention. Handle 10 comprises a first handle portion 12, a second handle portion 14, and a linking portion 16 connecting the second handle portion 14 to the first handle portion 12. The first handle portion is attachable to a device, such as a valve (not shown) for which the offset handle 10 acts as an actuator. To this end, the first handle portion may have an opening 18 which can receive a portion of the device, for example, a valve stern which is rotatable by the handle for opening and closing the valve. The second handle portion is grippable to permit manual rotation of the handle. Second handle portion 14 may have a cover 20 to enhance friction or act as a shield or cushion against sharp edges which may cut or otherwise injure a person actuating the device to which the offset handle is attached.

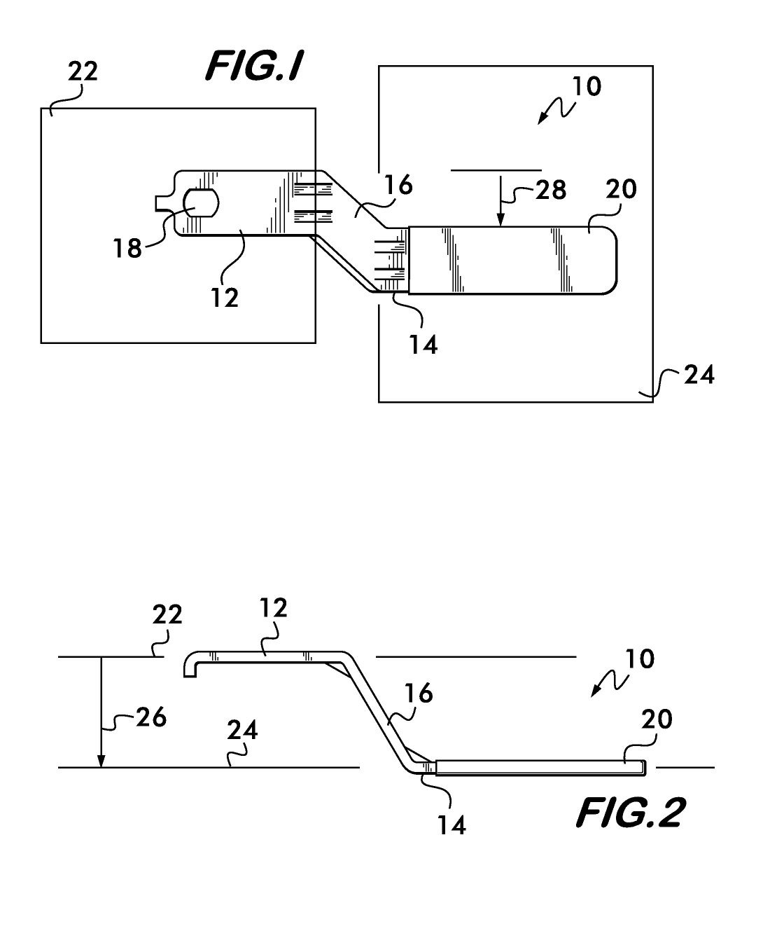

As shown in FIG. 2, the first handle portion 12 is located in a first plane 22 and the second handle portion is located in a second plane 24. Second plane 24 is preferably, though not necessarily, parallel to the first plane 22 and is offset from the first plane in a direction 26 substantially perpendicular to the first plane. The linking portion 16 is oriented transversely to the first and second planes 22 and 24. The planes 22 and 24 are imaginary and provide convenient references to describe the location and orientation of the first handle portion 12 relative to the second handle portion 14 and the linking portion.

With reference again to FIG. 1, it is shown that the second handle portion 14 may be offset from the first handle portion in a direction 28 which is substantially parallel to the first plane 22.

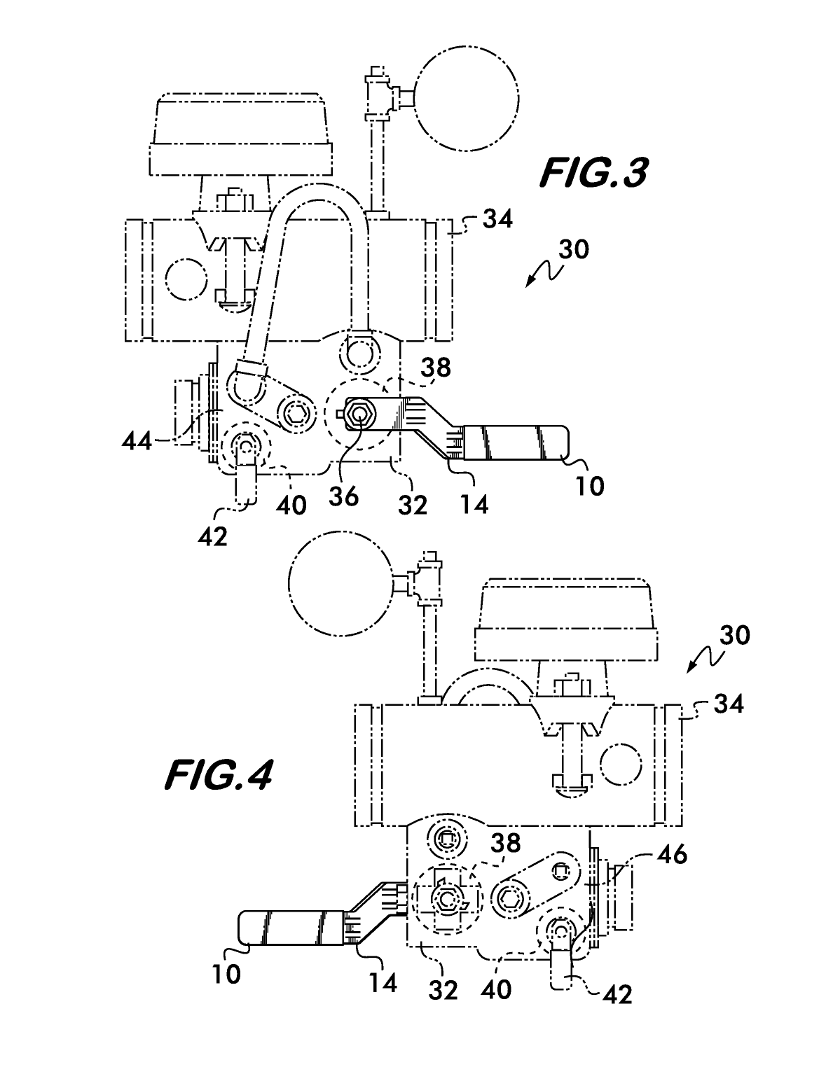

Exemplary use of the offset handle 10 according to the invention is illustrated in FIGS. 3-5 as an actuating handle for a test and drain valve assembly 30, shown in phantom line. As shown in FIG. 3, valve assembly 30 comprises a housing 32 mounted on a connection segment 34 which is attached in fluid communication with a riser pipe (not shown) of a fire suppression sprinkler system (also not shown). Offset handle 10 is attached to a valve stem 36 of a valve 38. The valve stem 36 is attached to a valve closing member, such as a ball for a ball valve located within the housing 32, and rotation of the stem via offset handle 10 opens and closes the valve 38, allowing or preventing water from the connection segment 34 to flow through the housing to a test and drain valve 40 also positioned within the housing 32, the test and drain valve being controlled by a selector 42.

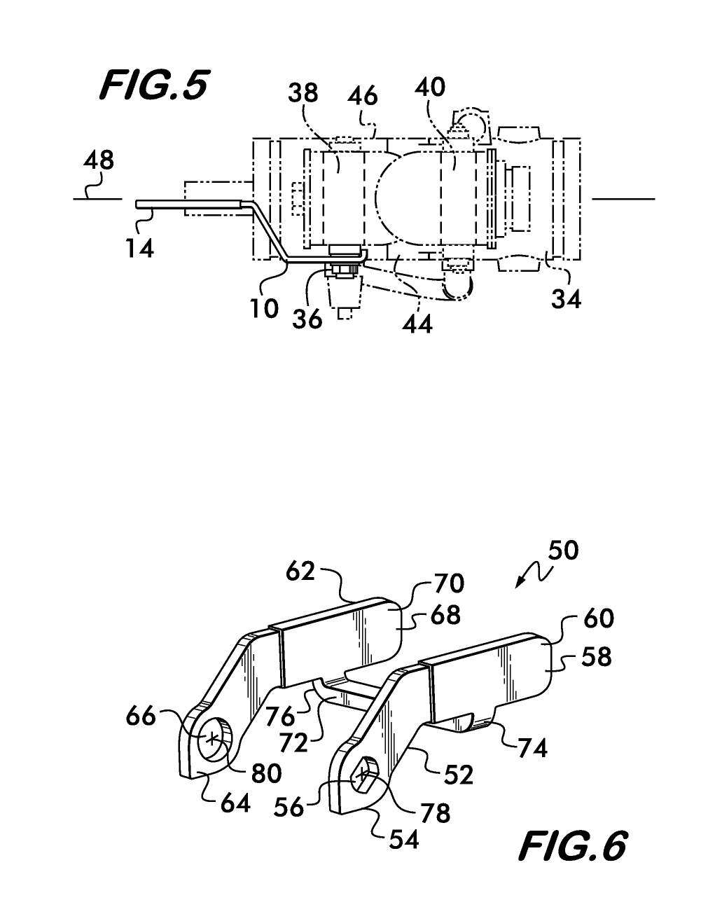

FIG. 3 shows a side 44 of the test and drain valve assembly 30 on which the offset handle is mounted, along with the other valve controls. FIG. 4 shows the opposite side 46 of the test and drain valve assembly. When the test and drain valve assembly is mounted on a riser pipe with side 44 facing away from a building structure, such as a wall, a technician has little or no difficulty setting the test and drain selector 42 to “test” or “drain” and then opening the valve 38 by rotating the offset handle 10 to allow water to flow from the connection segment 34 to the test and drain valve 40. However, for those situations wherein the side 46 is mounted facing away from the wall, the offset handle 10, which actuates valve 38, is on the opposite side of the valve assembly as shown in FIG. 4. For some reason, when a conventional handle (i.e., a handle which is not offset) is used under these conditions, technicians become confused as to which way to rotate the handle to open or close the valve 38 which controls the flow of water to the test and drain valve 40. Applicants have found that if the grippable portion 14 of the handle is offset so as to substantially align with the center line 48 of the housing 32 as shown in FIG. 5, then there is little or no confusion as to how to operate the valve.

FIG. 6 illustrates a dual linked handle embodiment 50 according to the invention. Handle 50 comprises a first handle portion 52. First handle portion 52 has a first end 54 which is attachable to a device, such as a valve. In this embodiment, first end 54 has an opening 56 shaped to receive a valve stem. First handle portion 52 also has a second end 58 disposed oppositely from the first end. Second end 58 is intended to be gripped, and may have a cover 60 to cushion the grip of a user and protect against cuts or other injury from sharp edges.

Handle 50 also includes a second handle portion 62 positioned in spaced relation to the first handle portion 52. This relationship permits the first and second handle portions to be positioned on opposite sides of a device, as described below for an example valve. Second handle portion 62 has a first end 64 which is attachable to a device. In this embodiment, first end 64 has an opening 66 shaped to receive a trunnion to permit rotation of the second handle portion. Second handle portion 62 also has a second end 68 disposed oppositely from the first end. Second end 68 is intended to be gripped, and may have a cover 70 to cushion the grip of a user and protect against cuts or other injury from sharp edges.

A linking portion 72 has a first end 74 attached to the first handle portion 52 and a second end 76 attached to the second handle portion 62. The linking portion 72 forces the handle portions to move together when one or the other is moved. To facilitate simultaneous rotation of the handle portions 52 and 62, the center of rotation 78 of the first handle portion 52, as defined by the position of opening 56, may be aligned with the center of rotation 80 of the first handle portion, allowing the handles to rotate simultaneously about the same axis, for example, the axis of rotation of a valve stem.

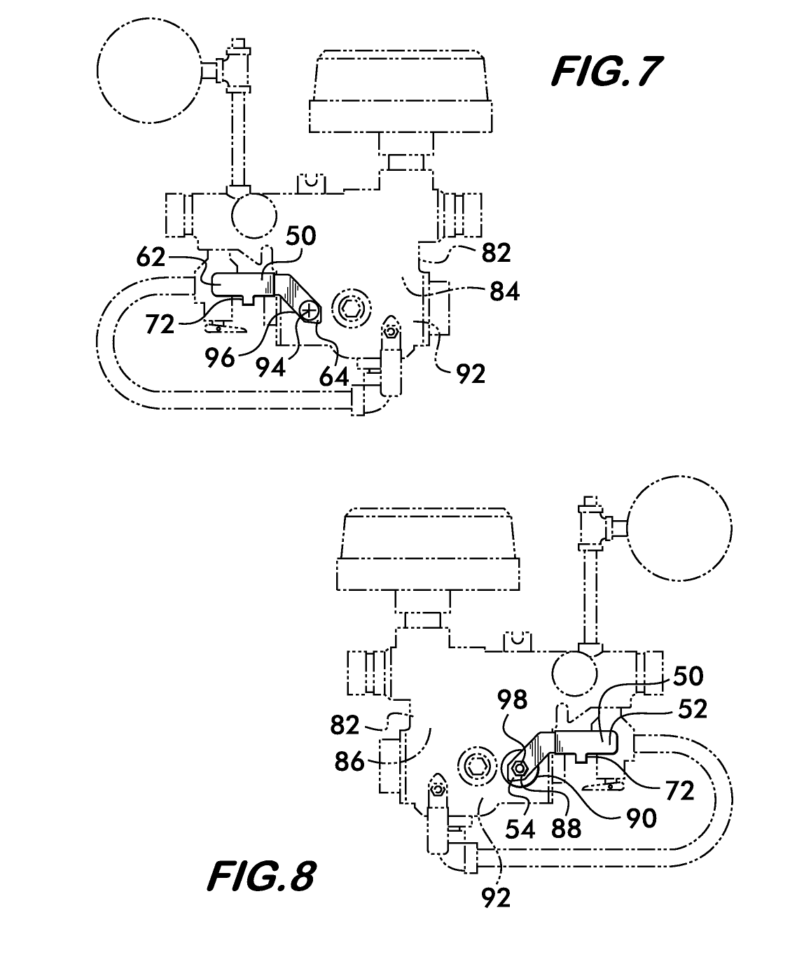

FIGS. 7 and 8 show an example dual linked handle 50 used on a test and drain valve assembly 82, shown in phantom line. The FIGS. 7 and 8 show the valve assembly 82 from opposite sides 84 and 86, thereby showing the handle portions 52 and 62 on each side of the valve assembly. FIG. 8 shows the first end 54 of first handle portion 52 attached to a valve stem 88 of a valve 90 located within a housing 92 of the valve assembly 82. When the valve assembly 82 is mounted with side 86 facing away from a wall or other building structure (FIG. 8), side 86 is readily accessible and the valve 90 may be easily opened or closed by manually gripping and rotating the first handle portion 52. The first handle portion is attached directly to the valve stem 88, and provides the required control over the valve, rotating a valve closing member (not shown) between an open and a closed position.

FIG. 7 shows the first end 64 of second handle portion 62 attached to a trunnion 94 extending from housing 92 of the valve assembly 82. The axis 96 of the trunnion is coaxially aligned with the axis 98 of the valve stem 88 (see FIG. 8). When the valve assembly 82 is mounted with side 84 facing away from a wall or other building structure (FIG. 7), side 84 is readily accessible and the valve 90 may be easily opened or closed by rotating the second handle portion 62. The second handle portion rotates about the trunnion 94 and is attached indirectly to the valve stem 88 through the linking portion 72 which connects the second handle portion to the first. Thus, when the second handle portion 62 is rotated about the trunnion 94 the linking portion 72 forces the first handle portion 52 to rotate the valve stem 88 and open or close the valve. The dual linked handle 50 thereby allows the valve assembly 82 to be easily operated from either side without confusion, and permits a standard valve 90 with a single valve stem to be used in the valve assembly.

The handles according to the invention permit valves and other devices to be operated without confusion from either side, thereby reducing potential mistakes and avoiding the need for left and right handed devices.

What is claimed is:

1. A handle for actuating a device, said handle comprising:
a first handle portion attachable to said device, said first handle portion being located in a first plane;
a second handle portion being located in a second plane oriented substantially parallel to and offset from said first handle portion in a direction substantially perpendicular to said first plane; and
a linking portion connecting said second handle portion to said first handle portion.

2. The handle according to claim 1, wherein said second handle portion is further offset from said first handle portion in a direction substantially parallel to said first plane.

3. A handle for actuating a device, said handle comprising:
a first handle portion attachable to said device, said first handle portion being located in a first plane;
a second handle portion being located in a second plane offset from said first handle portion in a direction substantially perpendicular to said first plane; and
a linking portion connecting said second handle portion to said first handle portion.

4. The handle according to claim 3, wherein said first and second planes are substantially parallel to one another.

5. The handle according to claim 4, wherein said second handle portion is further offset from said first handle portion in a direction substantially parallel to said first plane.

6. A valve, comprising:
a housing having first and second sides oppositely disposed, and a centerline positioned therebetween;
a closing member mounted within said housing, said closing member being movable between an open position and a closed position;
a valve stem attached to said closing member and projecting from said first side of said housing, rotation of said valve stem moving said closing member between said open and said closed positions;
a handle mounted on said valve stem for manually opening and closing said valve, said handle comprising:
a first handle portion located in a first plane and attached to said valve stem;
a second handle portion located in a second plane offset from said first plane and aligned with said centerline of said housing; and
a linking portion connecting said second handle portion to said first handle potion.

7. The valve according to claim 6, wherein said first and second planes are oriented substantially parallel to one another.

8. The valve according to claim 7, wherein said second handle portion is further offset from said first handle portion in a direction substantially parallel to said first and second planes.

9. A handle for actuating a device, said handle comprising:
a first handle portion having a first end attachable to said device and a second end oppositely disposed from said first end;
a second handle portion offset from said first handle portion in spaced relation so as to be positionable on an opposite side of said device from said first handle portion; and
a linking portion having a first end attached to said first handle portion and a second end attached to said second handle portion.

10. The handle according to claim 9, wherein said second handle portion comprises a first end rotatably attachable to said device, and a second end, oppositely disposed from said first end of said second handle portion, said second end of said second handle portion being grippable for rotation thereof.

11. The handle according to claim 10, wherein said linking portion is attached at a position between said first and second ends of said first and said second handle portions.

12. A valve, comprising:
a housing having first and second sides oppositely disposed;
a closing member mounted within said housing, said closing member being movable between an open position and a closed position;
a valve stem attached to said closing member and projecting from said first side of said housing, rotation of said valve stem moving said closing member between said open and said closed positions;
a first handle portion having a first end attached to said valve stem and a second end oppositely disposed from said first end;
a second handle portion positioned on said second side of said housing; and
a linking portion having a first end attached to said first handle portion and a second end attached to said second handle portion.

13. The valve according to claim 12, wherein said second handle portion comprises a first end rotatably mounted on said housing for rotation about an axis oriented parallel to said valve stem.

14. The valve according to claim 13, further comprising a trunnion projecting from said second side of said housing, said second handle portion being rotatably mounted on said trunnion.

15. The valve according to claim 12, wherein said second handle portion comprises a first end rotatably mounted on said housing for rotation about an axis coaxially aligned with said valve stem.

16. The valve according to claim 15, further comprising a trunnion projecting from said second side of said housing, said second handle portion being rotatably mounted on said trunnion.
